(19) United States
(12) Patent Application Publication
(10) Pub. No.: US 2017/0269590 A1
(43) Pub. Date: Sep. 21, 2017

(54) CONTROLLED DEVICE AND COMMUNICATION SYSTEM AND METHOD UTILIZING THE SAME

(71) Applicant: ZEROTECH (Chongqing) Intelligence Technology Co., Ltd., Chongqing (CN)

(72) Inventor: MINGLIANG FENG, Beijing (CN)

(21) Appl. No.: 15/402,816

(22) Filed: Jan. 10, 2017

(30) Foreign Application Priority Data
Mar. 15, 2016 (CN) 201610147391.9

(51) Int. Cl. G05D 1/00; B64C 39/02

(52) U.S. Cl. CPC G05D 1/0022; B64C 39/024; H04L 67/12

(57) ABSTRACT

The present disclosure relates to a communication system comprising a first remote control, a second remote control and a controlled device. The first remote control and the second remote control establish communication with the controlled device via a first communication link and a second communication link, respectively, so as to control the controlled device. The first remote control sends first transmission data to the controlled device, the second remote control sends second transmission data to the controlled device, and the controlled device transfers the first transmission data to the second remote control and transfers the second transmission data to the first remote control. The present disclosure further relates to a communication method and a controlled device. With the technical solutions provided herein, the remote controls communicate with each other by means of the controlled device, which makes the communication between the remote controls no longer restricted by a distance therebetween.

### CROSS-REFERENCE TO RELATED APPLICATION

The present application claims priority to and the benefit of the filing date of Chinese Patent Application No. CN201610147391.9, filed with the State Intellectual Property Office of China on Mar. 15, 2016, and entitled “Controlled Device and Communication System and Method Utilizing the Same,” the content of which is incorporated herein by reference in its entirety.

### FIELD

The present disclosure relates to the technical field of communication, and particularly to a controlled device and a communication system and method utilizing the same.

### BACKGROUND

An unmanned aerial vehicle, called “UAV” for short, is an unmanned aircraft manipulated by a radio remote control device and a self-contained program control means. The UAV undertakes tasks of ground monitoring, target tracking, military attacking and the like; furthermore, as having advantages of small size, strong flexibility and the like, the UAV plays an extremely important role in the military and civil fields. Performances of data links of the UAV directly determine the security and flight effectiveness of the UAV during the implementation of the tasks, and they are as if the brain and eyes of the UAV.

The data links of the UAV may be divided into an uplink and a downlink according to different data transfer directions. The uplink is mainly used to send remote control commands from a ground-based terminal to the UAV, so as to realize real-time control of flight attitudes and command automatization. The downlink is mainly used to transfer information, such as sensed data and reconnaissance images, from the UAV to the ground-based terminal.

The UAV may be controlled by two remote controls, and communicate with them via the uplink and the downlink. Generally, the communication between the two remote controls and the UAV is achieved in such a manner that, a second remote control sends control data to a first remote control, the first remote control gathers the control data sent from the second remote control and control data of the first remote control itself, packages the gathered control data together and sends them to the UAV, and the UAV interprets the received control data so as to perform various operations. Under this operating mode, there is a disadvantage that a distance between the two remote controls should not be too far; in addition, since the remote controls are generally located not very high from the ground, the communication between the two remote controls would be seriously affected if there is an obstacle between the remote controls.

### BRIEF DESCRIPTION OF THE DRAWINGS

In order to more clearly illustrate technical solutions of embodiments of the present disclosure, drawings of the embodiments will be introduced briefly hereinafter. It should be understood that the drawings below merely show some embodiments of the present disclosure, and therefore should not be considered as limiting the scope. Other relevant drawings can also be obtained, in light of these drawings, by a person ordinarily skilled in the art without paying inventive effort.

FIG. 1 is a systematic block diagram of a communication system provided by an embodiment of the present disclosure;

FIG. 2 is a functional module diagram of a first remote control of the communication system shown in FIG. 1;

FIG. 3 is a functional module diagram of a second remote control of the communication system shown in FIG. 1;

FIG. 4 is a functional module diagram of a controlled device of the communication system shown in FIG. 1;

FIG. 5 is another systematic block diagram of a communication system provided by an embodiment of the present disclosure; and

FIG. 6 is a flow chart of a communication method provided by an embodiment of the present disclosure.

### DETAILED DESCRIPTION

Technical solutions of embodiments of the present disclosure will be described clearly and completely hereinafter, in conjunction with drawings used for the embodiments of the present disclosure. Apparently, some but not all of embodiments of the present disclosure are described. Generally, components in the embodiments of the present disclosure, which are described and shown in the drawings herein, can be arranged and designed in different configurations. Therefore, the detailed description below of the embodiments of the present disclosure provided in the drawings is not intended to limit the scope of protection of the present disclosure, but merely represents chosen embodiments of the present disclosure. All the other embodiments, obtained by a person skilled in the art based on the embodiments of the present disclosure without paying inventive effort, fall within the scope of protection of the present disclosure.

It should be noted that similar reference signs and letters represent similar items in the following drawings, and therefore, once a certain item is defined in one drawing, it is not needed to be further defined or explained in subsequent drawings. Meanwhile, in the description of the present disclosure, terms, such as “first” and “second”, are merely for describing the distinction, but should not be construed as indicating or suggesting a relative significance.

Besides, it should be noted that the controlled device provided by the embodiment of the present disclosure may be a UAV, an unmanned ship, a robot and the like; and accordingly, the communication system provided by the embodiment of the present disclosure can be applied to fields of the UAV, the unmanned ship, the robot and the like.

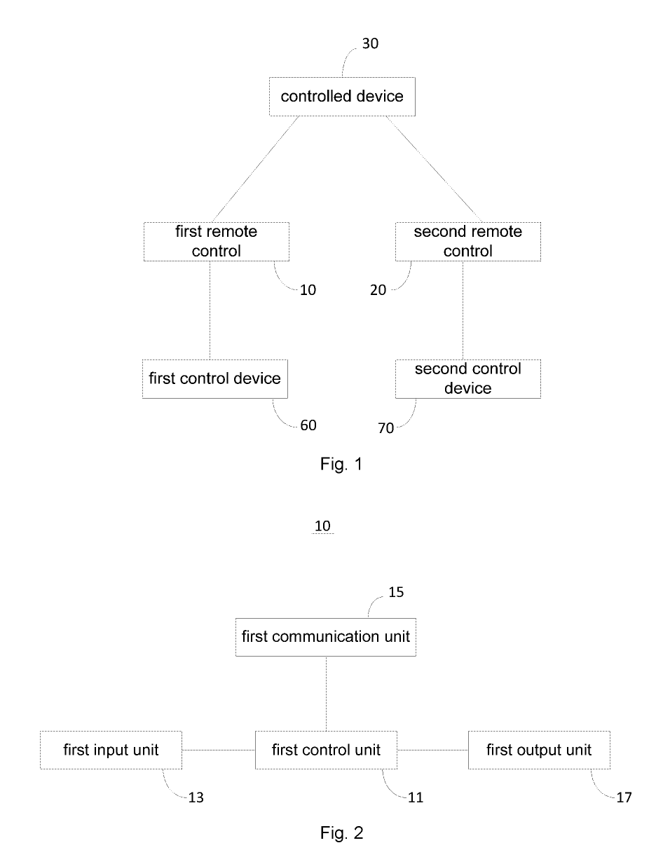

Referring to FIG. 1, a communication system 100 provided by an embodiment of the present disclosure includes a first remote control 10, a second remote control 20 and a controlled device 30. It should be noted that, in the present embodiment of the present disclosure, it is illustrated by taking a case that the controlled device 30 is a UAV as an example, but the controlled device may also be the above-mentioned unmanned ship, robot or the like. The controlled device 30 establishes communication with the first remote control 10 via a first communication link, and the controlled device 30 establishes communication with the second remote control 20 via a second communication link. The first communication link and the second communication link do not interfere with each other, and each of them includes an uplink and a downlink, that is, both the first communication link and the second communication link can perform two-way data transfer. In the present embodiment, the uplink is mainly used to send remote control commands from a ground-based terminal (for example, the first remote control 10 and the second remote control 20) to the controlled device 30, so as to realize real-time control of the controlled device 30 and command automatization; and the downlink is mainly used to transmit telemetric data (such as sensed data and reconnaissance images) from the controlled device 30 to the ground-based terminal (for example, the first remote control 10 and the second remote control 20).

The controlled device 30 is mounted with at least one load. The load may be a gimbal. Optionally, a means capable of photographing, such as a camera and a video camera, may be carried on the gimbal. The load may also be a sensing means, such as a temperature detector, an infrared detector and a multispectral scanner. Furthermore, the load may also be other external devices, such as a loudspeaker and a pesticide box. In the embodiment of the present disclosure, it is illustrated by taking a case that the load is a gimbal on which a video camera is carried as an example. One of the first remote control 10 and the second remote control 20 may be used to control a flight operation of the controlled device 30, and the other one may be used to control a load operation of the controlled device 30. In the present embodiment of the present disclosure, it is illustrated by taking a case that the first remote control 10 is used to control the flight operation of the controlled device 30 and the second remote control 20 is used to control the gimbal operation of the controlled device 30 as an example. However, in other embodiments, the first remote control 10 may also be used to control the gimbal operation of the controlled device 30, and the second remote control 20 may also be used to control the flight operation of the controlled device 30. It can be understood that the above flight operation may include but not limited to taking-off, hovering, bending-over, direction changing, accelerating, landing and the like. The above gimbal operation may refer to photographing with at least one video camera on the controlled device 30, a rotation of the gimbal itself, and the like.

Specifically, both the first remote control 10 and the second remote control 20 store a plurality of commands for controlling the flight operation and the gimbal operation of the controlled device 30. Referring to FIG. 1 again, the communication system 100 provided by the embodiment of the present disclosure further includes a first control device 60 electrically connected with the first remote control 10 and a second control device 70 electrically connected with the second remote control 20. The first remote control 10 may be set, by means of the first control device 60, for controlling the flight operation of the controlled device 30, and the second remote control 20 may be set, by means of the second control device 70, for controlling the gimbal operation of the controlled device 30. Preferably, the first control device 60 may perform the setting on the first remote control 10 by inputting to the first remote control 10 a control passcode corresponding to a command for controlling the flight operation, and the second control device 70 may perform the setting on the second remote control 20 by inputting to the second remote control 20 a control passcode corresponding to a command for controlling the gimbal operation, thereby enabling, on software, the first remote control 10 to call only the command for controlling the flight operation of the controlled device 30 and the second remote control 20 to call only the command for controlling the gimbal operation of the controlled device 30. Of course, the first remote control 10 and the second remote control 20 may also have their corresponding control types set by means of their own control buttons, respectively. For example, by single-clicking a control button on the first remote control 10, the first remote control 10 may be set for controlling the flight operation of the controlled device 30; and by double-clicking a control button on the second remote control 20, the second remote control 20 may be set for controlling the gimbal operation of the controlled device 30. It can be understood that, with the above setting mode performed by inputting the control passcodes, the first remote control 10 may also be enabled to call only the command for controlling the gimbal operation of the controlled device 30, and the second remote control 20 may also be enabled to call the command for controlling the flight operation of the controlled device 30. Correspondingly, by single-clicking the control button on the first remote control 10, the first remote control 10 may also be set for controlling the gimbal operation of the controlled device 30; and by double-clicking the control button on the second remote control 20, the second remote control 20 may also be set for controlling the flight operation of the controlled device 30.

It is worth mentioning that the above first control device 60 and second control device 70 may be a portable electronic device, such as a cellphone, a tablet computer and glasses, and they may be provided respectively on the first remote control 10 and the second remote control 20 in a clamping or suspending manner or the like, so as to be carried easily. Moreover, the first remote control 10 and the second remote control 20 may further transfer feedback information received from the controlled device 30 to the first control device 60 and the second control device 70, respectively, so as to make them displayed by display screens of the first control device 60 and the second control device 70.

It can be understood that each of the first remote control 10 and the second remote control 20 may also have a self-contained display screen so as to display the feedback information from the controlled device 30. Furthermore, the first control device 60 may also be integrated with the first remote control 10, and the second control device 70 may also be integrated with the second remote control 20, where specific implementations of the present disclosure are not limited thereto.

Referring to FIG. 2, specifically, the first remote control 10 may include a first control unit 11 and a first input unit 13, a first communication unit 15 and a first output unit 17, each being electrically connected with the first control unit 11.

The first input unit 13 is used to input first control information, the first control information may include first control data used for controlling the flight operation of the controlled device 30 and first transmission data intended to be transmitted to the second remote control 20. In the present embodiment, the first input unit 13 may be operation buttons on the first remote control 10 for allowing a user to input the first control information, such as a plurality of commands for controlling the flight operation of the controlled device 30. It can be understood that the first input unit 13 may also be a microphone for collecting voices of the user, and the first control information may correspondingly be voice information. It can be understood that the first control information may also be in the form of text, image or the like.

Upon receiving the first control information input through the first input unit 13, the first control unit 11 may control the first communication unit 15 to establish communication with the controlled device 30 via the first communication link, so as to send the first control information to the controlled device 30. In a specific implementation, the first control unit 11 may, before controlling the first communication unit 15 to send the first control information, process (for example, compress, encode or encrypt) the first control information, and then control the first communication unit 15 to send the processed first control information. Furthermore, the first communication unit 15 is further used to receive first feedback information transferred by the controlled device 30 and transfer the first feedback information to the first control unit 11. The first control unit 11 is further used to process (for example, decompress, decode or decrypt) the first feedback information, and transfer the processed first feedback information to the first output unit 17. The first output unit 17 is electrically connected with the first control device 60 (as shown in FIG. 1), so as to transfer the first feedback information transferred by the first control unit 11 to the first control device 60 for display. In addition, the first output unit 17 may further include a loudspeaker for playing voice information sent from the second remote control 20 (which will be described in detail hereinafter).

It should be indicated that the first control data and the first transmission data included in the first control information may be sent simultaneously, or may also be sent separately, where specific implementations of the present disclosure are not limited thereto. Each of the first control data and the first transmission data includes a corresponding type identifier, and the controlled device may identify the first control data and the first transmission data from the first control information, based on their corresponding type identifiers. As mentioned above, the first control data is used to control the flight operation of the controlled device 30, and it may be input through operation buttons or a self-contained display screen (such as a touch screen) on the first remote control 10. As to the first transmission data, which may be at least one of text data, image data and voice data and transmitted to the second remote control 20 by means of the controlled device 30, it may also be input through the operation buttons or the self-contained display screen on the first remote control 10, or may also be input through the microphone on the first remote control 10. In addition, the above first feedback information includes the telemetric data of the controlled device 30 and the second transmission data sent from the second remote control 20, which will be described in detail hereinafter.

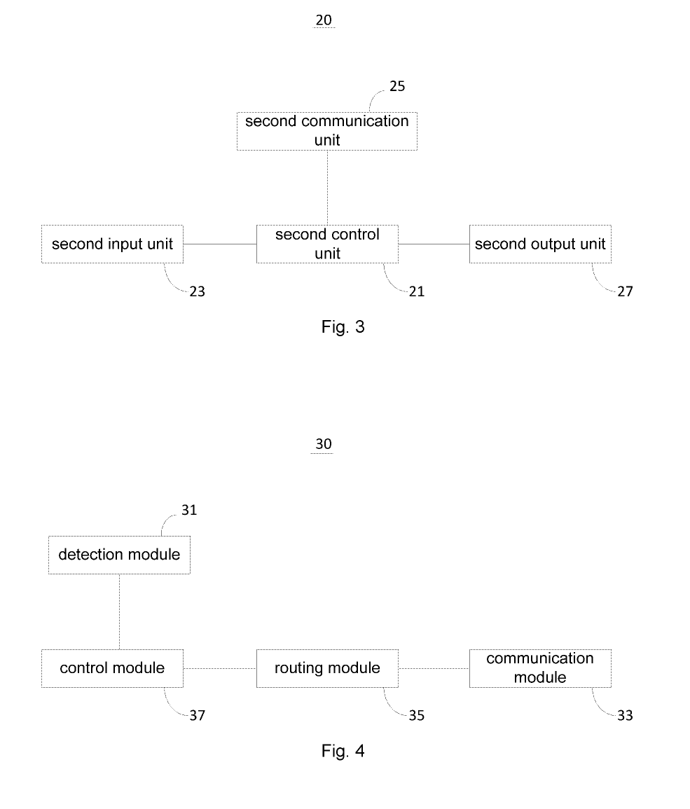

Referring to FIG. 3, in another aspect, the second remote control 20 may include a second control unit 21 and a second input unit 23, a second communication unit 25 and a second output unit 27 each being electrically connected with the second control unit 21.

The second input unit 23 is used to input second control information, the second control information may include second control data used for controlling the gimbal operation of the controlled device 30 and second transmission data intended to be transmitted to the first remote control 10. In the present embodiment, the second input unit 23 may be operation buttons on the second remote control 20 for allowing the user to input the second control information, such as a plurality of commands for controlling the gimbal operation of the controlled device 30. It can be understood that the second input unit 23 may also be a microphone for collecting voices of the user, and the second control information may correspondingly be voice information.

Upon receiving the second control information input through the second input unit 23, the second control unit 21 may control the second communication unit 25 to establish communication with the controlled device 30 via the second communication link, so as to send the second control information to the controlled device 30. In a specific implementation, similar to the first control unit 11, the second control unit 21 may also, before controlling the second communication unit 25 to send the second control information, process (for example, compress, encode or encrypt) the second control information, and then control the second communication unit 25 to send the processed second control information. Furthermore, the second communication unit 25 is further used to receive second feedback information transferred by the controlled device 30 and transfer the second feedback information to the second control unit 21. The second control unit 21 is further used to process (for example, decompress, decode or decrypt) the second feedback information, and transfer the processed second feedback information to the second output unit 27. The second output unit 27 is electrically connected with the second control device 70 (as shown in FIG. 1), so as to transfer the second feedback information transferred by the second control unit 21 to the second control device 70 for display. In addition, the second output unit 27 may further include a loudspeaker for playing voice information sent from the first remote control 10.

It should be indicated that the second control data and the second transmission data included in the second control information may be sent simultaneously, or may also be sent separately, where specific implementations of the present disclosure are not limited thereto. Each of the second control data and the second transmission data includes a corresponding type identifier, and the controlled device may identify the second control data and the second transmission data from the second control information, based on their corresponding type identifiers. As mentioned above, the second control data is used to control the gimbal operation of the controlled device 30, and it may be input through operation buttons or a self-contained display screen (such as a touch screen) on the second remote control 20. As to the second transmission data, which may be at least one of text data, image data and voice data and transmitted to the first remote control 10 by means of the controlled device 30, it may also be input through the operation buttons or the self-contained display screen on the second remote control 20, or may also be input through the microphone on the second remote control 20. In addition, the above second feedback information includes the telemetric data of the controlled device 30 and the first transmission data sent from the first remote control 10, which will be described in detail hereinafter.

Referring to FIG. 4, the controlled device 30 includes a detection module 31, a communication module 33, a routing module 35 and a control module 37. The detection module 31 is electrically connected with the control module 37, and the routing module 35 is electrically connected between the communication module 33 and the control module 37.

The detection module 31 is used to acquire the telemetric data of the controlled device 30 and send the telemetric data to the control module 37. The telemetric data may include: sensed data, such as attitude, height and direction, of the controlled device 30 sensed by various sensing elements, such as an inertial measurement unit (IMU), a barometer, a magnetic sensor and a GPS; and reconnaissance images taken by the video camera carried on the gimbal of the controlled device 30. It should be indicated that, the detection module 31 may be activated when the controlled device 30 starts up, so as to collect the telemetric data in a real time manner; alternatively, the detection module 31 may also collect the telemetric data according to a corresponding control command received by the controlled device 30, where specific implementations of the present disclosure are not limited thereto.

The communication module 33 is used to establish two-way communication with the first communication unit 15 of the first remote control 10, so as to receive the first control information sent from the first communication unit 15 and send the first feedback information to the first communication unit 15. The first feedback information includes the telemetric data of the controlled device 30 and the second transmission data sent from the second remote control 20. Besides, this communication module 33 is further used to establish two-way communication with the second communication unit 25 of the second remote control 20, so as to receive the second control information sent from the second communication unit 25 and send the second feedback information to the second communication unit 25. The second feedback information includes the telemetric data of the controlled device 30 and the first transmission data sent from the first remote control 10. It can be understood that this communication module 33 can establish communication links based on identity information (ID) of the first remote control 10 and the second remote control 20, respectively. For example, the communication module 33 can comprise a first communication module and a second communication module, where the first communication module is used to establish the first communication link with the first communication unit 15, so as to transfer information having a destination address or a source address related to the ID of the first remote control 10, and the second communication module is used to establish the second communication link with the second communication unit 25, so as to transfer information having a destination address or a source address related to the ID of the second remote control 20.

The routing module 35 is used to send the first control information and the second control information received by the communication module 33 to the control module 37. Besides, the routing module 35 is further used to send the telemetric data, the first transmission data and the second transmission data output by the control module 37 to the communication module 33. For example, the routing module 35 may send the telemetric data and the second transmission data having a destination address related to the ID of the first remote control 10 to the above first communication module, and may send the telemetric data and the first transmission data having a destination address related to the ID of the second remote control 20 to the above second communication module.

The control module 37 is used to process the first control information and the second control information sent by the routing module 35, and process the telemetric data sent by the detection module 31. Furthermore, upon receiving the first control information, the control module 37 identifies the first control information so as to obtain at least one of the first control data and the first transmission data. For example, the control module 37 may perform this identification operation by utilizing specific type identifiers associated with the first control data and the first transmission data respectively. Thereafter, the control module 37 may control the flight operation of the controlled device 30 according to the first control data identified from the first control information, and/or send the first transmission data identified from the first control information and the telemetric data of the controlled device 30 itself to the second remote control 20 through the routing module 35 and the communication module 33. In a specific implementation, the control module 37 may send to the routing module 35 the first transmission data and the telemetric data after making them processed. For example, the control module 37 may set the destination address of the first transmission data and the telemetric data to be associated with the ID of the second remote control 20, and perform a processing, such as a compressing, encoding or encrypting operation, on the first transmission data and the telemetric data, so that the routing module 35 may send the first transmission data and the telemetric data, after being processed by the control module 37, with the second communication module (correspondingly, via the second communication link) according to the destination address.

Upon receiving the second control information, the control module 37 identifies the second control information so as to obtain at least one of the second control data and the second transmission data. For example, the control module 37 may perform this identification operation by utilizing specific type identifiers associated with the second control data and the second transmission data respectively. Thereafter, the control module 37 may control the gimbal operation of the controlled device 30 according to the second control data identified from the second control information, and/or send the second transmission data identified from the second control information and the telemetric data of the controlled device 30 itself to the first remote control 10 through the routing module 35 and the communication module 33. In a specific implementation, the control module 37 may send to the routing module 35 the second transmission data and the telemetric data after making them processed. For example, the control module 37 may set the destination address of the second transmission data and the telemetric data to be associated with the ID of the first remote control 10, and perform a processing, such as a compressing, encoding or encrypting operation, on the second transmission data and the telemetric data, so that the routing module 35 may send the second transmission data and the telemetric data, after being processed by the control module 37, with the first communication module (correspondingly, via the first communication link) according to the destination address.

Of course, the telemetric data may be transferred to the first remote control 10 and the second remote control 20 independently, that is, it is not necessary for the telemetric data to be transferred simultaneously with the first transmission data or the second transmission data. In fact, the telemetric data may be transferred in a real time manner, or may also be transferred at a predetermined time interval.

It should be indicated that, the routing module 35 and the control module 37 are shown in FIG. 4 as discrete components, but the routing module 35 and the control module 37 described above may also be integrated together, for example, the two may be integrated within a central processing unit (CPU) of the controlled device 30.

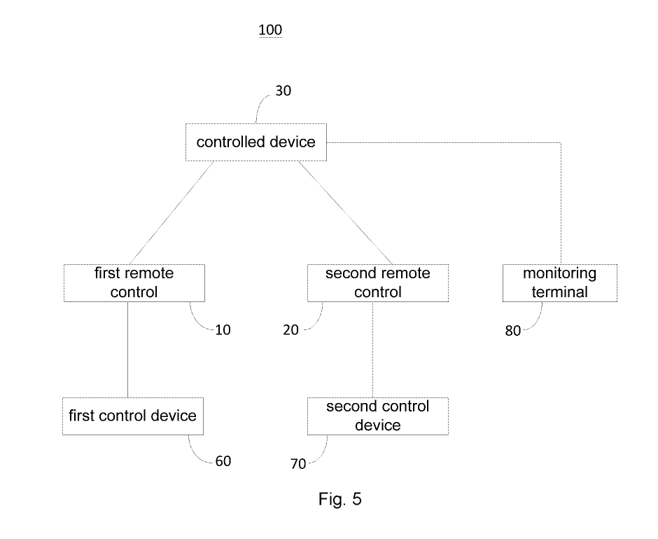

Referring to FIG. 5, the communication system 100 provided by the embodiment of the present disclosure may further include a monitoring terminal 80. The monitoring terminal 80 establishes one-way communication with the controlled device 30, so as to acquire information transferred by the controlled device 30, for example, the telemetric data of the controlled device 30, thereby enabling the ground-based terminal to monitor the controlled device 30. It can be understood that the number of the monitoring terminal 80 may be one or more, and the monitoring terminal 80 may be an electronic device having a display function, such as a personal computer, a tablet computer and a cell phone.

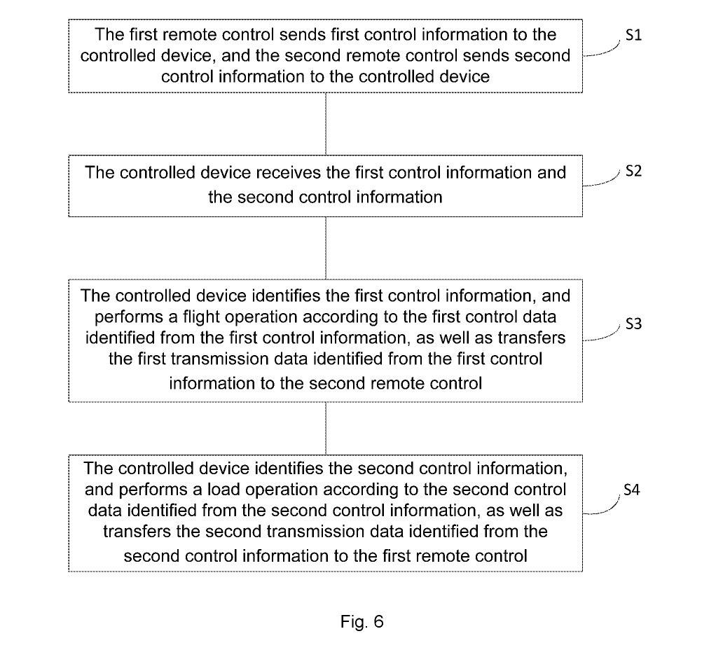

FIG. 6 shows the working principle of the communication system 100 provided by the embodiment of the present disclosure. As shown in FIG. 6, a flow of the communication method of an embodiment of the present disclosure includes steps as follows.

Step S1, the first remote control 10 sends first control information to the controlled device 30, and the second remote control 20 sends second control information to the controlled device 30, where the first control information includes first control data and first transmission data, and the second control information includes second control data and second transmission data.

The above first control information is transferred to the communication module 33 of the controlled device 30 through the first communication unit 15 of the first remote control 10, and the second control information is transferred to the communication module 33 of the controlled device 30 through the second communication unit 25 of the second remote control 20. Of course, the first control data and the first transmission data may be sent simultaneously, or they may be sent separately; similarly, the second control data and the second transmission data may be sent simultaneously, or they may be sent separately. Moreover, although both the first remote control 10 and the second remote control 20 send information to the controlled device 30 as described in the above step S1, there is no limitation on the first remote control 10 and the second remote control 20 that they have to send the information simultaneously. In fact, the first remote control 10 and the second remote control 20 may send the information to the controlled device 30 separately.

Step S2, the controlled device 30 receives the first control information and the second control information.

Specifically, the communication module 33 of the controlled device 30 receives the first control information and the second control information and transfers them to the control module 37. Correspondingly, in the present disclosure, there is no limitation on the controlled device 30 that it must receive the first control information and the second control information simultaneously. In fact, the first control information and the second control information may be received separately.

Step S3, the controlled device 30 identifies the first control information, and performs a flight operation according to the first control data identified from the first control information, and/or transfers the first transmission data identified from the first control information to the second remote control 20.

Specifically, after identifying the first control data from the first control information, the controlled device 30 is controlled to perform the flight operation according to the first control data; and after identifying the first transmission data from the first control information, the controlled device 30 transfers the first transmission data to the second remote control 20 through the routing module 35 and the communication module 33. That is to say, in this situation, the second remote control 20 can receive the first transmission data sent from the first remote control 10. In the case where the first transmission data is voice data, the second remote control 20 may play, by means of the loudspeaker thereof, this voice data sent from the first remote control 10. In another aspect, the controlled device 30 may collect the telemetric data (for example, continuously) with the detection module 31, and send the collected telemetric data to the second remote control 20 through the routing module 35 and the communication module 33, so that the second remote control 20 may make, upon receiving the telemetric data sent by the controlled device 30, the telemetric data displayed with the second control device 70 or a self-contained display screen for view.

Step S4, the controlled device 30 identifies the second control information, and performs a gimbal operation according to the second control data identified from the second control information, and/or transfers the second transmission data identified from the second control information to the first remote control 10.

Specifically, after identifying the second control data from the second control information, the controlled device 30 is controlled to perform the gimbal operation according to the second control data; and after identifying the second transmission data from the second control information, the controlled device 30 transfers the second transmission data to the first remote control 10 through the routing module 35 and the communication module 33. That is to say, in this situation, the first remote control 10 can receive the second transmission data sent from the second remote control 20. In the case where the second transmission data is voice data, the first remote control 10 may play, by means of the loudspeaker thereof, this voice data sent from the second remote control 20. In this way, voice communication may be realized between the first remote control 10 and the second remote control 20, thereby facilitating real-time talkback therebetween. In another aspect, this controlled device 30 may collect the telemetric data (for example, continuously) with the detection module 31, and send the collected telemetric data to the first remote control 10 through the routing module 35 and the communication module 33, so that the first remote control 10 may make, upon receiving the telemetric data sent by the controlled device 30, the telemetric data displayed with the first control device 60 or a self-contained display screen for view.

It should be indicated that, the order of the above steps S3 and S4 may also be reversed, or steps S3 and S4 may be performed concurrently, as long as the establishment of communication (for example, voice communication) between the first remote control 10 and the second remote control 20 can be ensured. Moreover, since the communication (for example, voice communication) between the first remote control 10 and the second remote control 20 is established by means of the controlled device 30, positions of the first remote control 10 and the second remote control 20 and a distance therebetween may be flexibly adjusted. For example, the first remote control 10 may be provided indoors, and the second remote control 20 may be provided outdoors; alternatively, the first remote control 10 and the second remote control 20 may be provided at two sides of a mountain; alternatively, the first remote control 10 may be provided at the site of an accident, and the second remote control 20 may be provided at a distant monitoring site. In the multiple scenes described above, the distance between the first remote control 10 and the second remote control 20 may not be limited, and a distance between the controlled device 30 and the first remote control 10 and a distance between the controlled device 30 and the second remote control 20 each may be set according to communication capacities of respective means and on-site obstacles. For example, the distance between the first remote control 10 and the controlled device 30 and the distance between the second remote control 20 and the controlled device 30 each are preferably 2 to 4 kilometers.

It should be specially indicated that, the communication system 100 and method provided by embodiments of the present disclosure are not limited to involving only the first remote control 10 and the second remote control 20 described in the embodiments, more remote controls may further be involved, for example, a third remote control and a fourth remote control. That is to say, with the communication method provided by the embodiment of the present disclosure, a plurality of remote controls can communicate with each other by means of the controlled device 30. For example, the first transmission data in the form of voice output by the first remote control 10 may be transferred to the second remote control 20, the third remote control and the fourth remote control by means of the controlled device 30, and the first remote control 10 may receive the transmission data in the form of voice transferred by the second remote control 20, the third remote control and the fourth remote control be means of the controlled device 30; and in this way, multi-party talkback is realized among the plurality of remote controls, thereby forming one talkback system.

In the communication system 100 and method provided by the embodiments of the present disclosure, the controlled device 30 receives the first transmission data sent by the first remote control 10 and the second transmission data sent by the second remote control 20, and the controlled device 30 transfers the first transmission data to the second remote control 20 and the second transmission data to the first remote control 10. In this way, the first remote control 10 and the second remote control 20 can establish communication (for example, voice communication) by means of the controlled device 30, enabling restriction caused by the distance between the two remote controls on the communication therebetween to be eliminated, that is, the two remote controls can communicate normally with each other in the case that there is a long distance therebetween, and enabling influences caused by obstacles existing between the remote controls on the communication therebetween to be significantly reduced.

It should be noted that similar reference signs and letters represent similar items in the following drawings, and therefore, once a certain item is defined in one drawing, it is not needed to be further defined or explained in subsequent figures.

The foregoing is merely representative of specific embodiments of the present disclosure, while the scope of protection of the present disclosure is not limited thereto. Alterations or substitutions, which can be easily contemplated by any person skilled in the art within the technical scope disclosed in the present disclosure, should fall within the scope of protection of the present disclosure. Therefore, the scope of protection of the present disclosure should be determined by the scope of protection of the claims.

1. A communication system, wherein the communication system comprises a first remote control, a second remote control and a controlled device, the first remote control establishes communication with the controlled device via a first communication link so as to control the controlled device, the second remote control establishes communication with the controlled device via a second communication link so as to control the controlled device, the first remote control is configured to send first transmission data to the controlled device, the second remote control is configured to send second transmission data to the controlled device, and the controlled device is configured to transfer the first transmission data to the second remote control and transfer the second transmission data to the first remote control.

2. The communication system according to claim 1, wherein the first remote control comprises a first control unit, and a first input unit, a first communication unit and a first output unit, each being electrically connected with the first control unit, the first input unit is configured to input the first transmission data, the first control unit is configured to, upon receiving the first transmission data input through the first input unit, make the first communication unit establish communication with the controlled device via the first communication link so as to send the first transmission data to the controlled device, the first communication unit is further configured to receive the second transmission data transferred by the controlled device and transfer the second transmission data to the first control unit, the first control unit is further configured to process the second transmission data and transfer the processed second transmission data to the first output unit, and the first output unit is configured to output the processed second transmission data.

3. The communication system according to claim 1, wherein the second remote control comprises a second control unit, and a second input unit, a second communication unit and a second output unit, each being electrically connected with the second control unit, the second input unit is configured to input the second transmission data, the second control unit is configured to, upon receiving the second transmission data input through the second input unit, make the second communication unit establish communication with the controlled device via the second communication link so as to send the second transmission data to the controlled device, the second communication unit is further configured to receive the first transmission data transferred by the controlled device and transfer the first transmission data to the second control unit, the second control unit is further configured to process the first transmission data and transfer the processed first transmission data to the second output unit, and the second output unit is configured to output the processed first transmission data.

4. The communication system according to claim 1, wherein the controlled device comprises a communication module, a routing module and a control module, the routing module is electrically connected between the communication module and the control module, the communication module is configured to receive the first transmission data sent by the first remote control and the second transmission data sent by the second remote control, the routing module is configured to send the first transmission data and the second transmission data received by the communication module to the control module, and the control module is configured to, after identifying the first transmission data and the second transmission data, transfer the first transmission data to the second remote control through the routing module and the communication module and transfer the second transmission data to the first remote control through the routing module and the communication module.

5. The communication system according to claim 4, wherein the controlled device further comprises a detection module, the detection module is configured to collect telemetric data and transfer the telemetric data to the control module, and the control module is configured to process the telemetric data and send the processed telemetric data to the first remote control and the second remote control through the routing module and the communication module.

6. The communication system according to claim 1, wherein the first remote control is further configured to send first control data to the controlled device so as to control a flight operation of the controlled device, and the second remote control is further configured to send second control data to the controlled device so as to control a load operation of the controlled device.

7. The communication system according to claim 6, wherein the communication system further comprises a first control device electrically connected with the first remote control and a second control device electrically connected with the second remote control, the first remote control is set, by means of the first control device, for controlling the flight operation of the controlled device, and the second remote control is set, by means of the second control device, for controlling the load operation of the controlled device.

8. The communication system according to claim 1, wherein the first transmission data comprises at least one of text data and voice data, and the second transmission data comprises at least one of text data and voice data.

9. A communication method, wherein the communication method comprises:
receiving first control information from a first remote control, and receiving second control information from a second remote control, wherein the first control information comprises first transmission data, and the second control information comprises second transmission data;
identifying the first transmission data from the first control information, and transferring the first transmission data to the second remote control; and
identifying the second transmission data from the second control information, and transferring the second transmission data to the first remote control.

10. The communication method according to claim 9, wherein the communication method further comprises:
collecting telemetric data; and
sending the telemetric data to the first remote control and the second remote control.

11. The communication method according to claim 9, wherein the first control information further comprises first control data and the second control information further comprises second control data, and the communication method further comprises:
controlling a flight operation according to the first control data and controlling a load operation according to the second control data.

12. The communication method according to claim 9, wherein the step of identifying the first transmission data from the first control information and identifying the second transmission data from the second control information comprises:
identifying the first transmission data from the first control information and the second transmission data from the second control information according to type identifiers of transmission data.

13. The communication method according to claim 9, wherein the first transmission data and the second transmission data each comprise at least one of text data, image data and voice data.

14. A controlled device, communicating with a first remote control and a second remote control, wherein the controlled device is configured to receive first control data and first transmission data sent by the first remote control and receive second control data and second transmission data sent by the second remote control, the controlled device is configured to perform different operations according to the first control data and the second control data, respectively, and the controlled device is further configured to transfer the first transmission data to the second remote control and transfer the second transmission data to the first remote control.

15. The controlled device according to claim 14, wherein the controlled device comprises a communication module, a routing module and a control module, the routing module is electrically connected between the communication module and the control module, the communication module is configured to establish communication with the first remote control so as to receive the first transmission data sent by the first remote control, and to establish communication with the second remote control so as to receive the second transmission data sent by the second remote control, the routing module is configured to send the first transmission data and the second transmission data received by the communication module to the control module, and the control module is configured to, after identifying the first transmission data and the second transmission data, transfer the first transmission data to the second remote control through the routing module and the communication module and transfer the second transmission data to the first remote control through the routing module and the communication module.

16. The controlled device according to claim 15, wherein the communication module is further configured to receive the first control data and the second control data, and the control module is configured to control a flight operation of the controlled device according to the first control data, and to control a load operation of the controlled device according to the second control data.

17. The controlled device according to claim 15, wherein the controlled device further comprises a detection module, the detection module is configured to collect telemetric data and transfer the telemetric data to the control module, and the control module is configured to process the telemetric data, and send the processed telemetric data to the first remote control and the second remote control through the routing module and the communication module.

18. The controlled device according to claim 15, wherein the control module is configured to identify the first transmission data from the first control information and the second transmission data from the second control information according to type identifiers of transmission data.

19. The controlled device according to claim 14, wherein the controlled device is unmanned aerial vehicle.

20. The controlled device according to claim 14, wherein the first transmission data and the second transmission data each comprise at least one of text data, image data and voice data.
